(19) United States
(12) Patent Application Publication
(10) Pub. No.: US 2026/0309297 A1
(43) Pub. Date: Oct. 8, 2026

(54) SNAP-IN LIGHTHEAD ASSEMBLY FOR LIGHTBAR

(71) Applicant: WHELEN ENGINEERING COMPANY, INC., Chester, CT (US)

(72) Inventor: Kristopher Allan Terpe, Cobalt, CT (US)

(73) Assignee: WHELEN ENGINEERING COMPANY, INC., Chester, CT (US)

(21) Appl. No.: 19/638,557

(22) Filed: Apr. 3, 2026

Related U.S. Application Data
(60) Provisional application No. 63/784,158, filed on Apr. 6, 2025.

(51) Int. Cl. F21S 43/19; F21S 41/141; F21S 41/19; F21S 43/14; F21S 45/48

(52) U.S. Cl. CPC F21S 43/195; F21S 41/141; F21S 41/192; F21S 41/198; F21S 43/14; F21S 45/48

(57) ABSTRACT

A lightbar optical assembly includes an extrusion and optical sub-assembly. The extrusion includes a base, a mating undercut, and a protrusion. The optical sub-assembly includes a mounting bracket having a mounting bracket base and mounting bracket front edge of the mounting bracket base, optical engines attachable to the mounting bracket, a control printed circuit board assembly (PCBA), and a snapping bracket having snapping legs. The snapping bracket is secured to the mounting bracket and the control PCBA and is attachable to the extrusion. The mounting bracket front edge contacts the mating undercut and the snapping legs contact the protrusion thereby securing the optical sub-assembly to the extrusion.

### CROSS-REFERENCE TO RELATED APPLICATIONS

This application is related to and claims the benefit of priority from U.S. Provisional Application No. 63/784,158, titled “SNAP-IN LIGHTHEAD ASSEMBLY FOR LIGHTBAR,” filed on Apr. 6, 2025, the full disclosure of which is hereby incorporated by reference in its entirety for all purposes.

### BACKGROUND

### 1. Field of Disclosure

Embodiments of the present disclosure generally relate to lightbar assemblies, and particularly, embodiments relate to retention mechanisms for use with lightbars having extrusions for mounting lighting components used with public safety and emergency response vehicles.

### 2. Description of Related Art

Lightbar technology has undergone significant advancements over the past few decades, particularly in the context of public safety and emergency response vehicles. Initially, lightbars were simple arrays of incandescent or halogen bulbs, primarily designed to provide visibility and alert drivers to the presence of emergency vehicles. However, the introduction of LED technology has revolutionized this space, offering enhanced brightness, energy efficiency, and durability. The addition of LEDs into emergency vehicle lightbars has also allowed lights to be more versatile. Further, some modern lightbars have evolved into multifunctional tools, integrating various features such as automated adjustments based on vehicle actions and digital communication systems.

Despite these advancements, there are ongoing challenges in the assembly and retention of light sources and other components within lightbars and other equipment having an extrusion for mounting components. Ensuring reliable and stable retention mechanisms without compromising the ease of assembly remains an area of focus for engineers in the field. Simplifying the assembly process while maintaining high standards of reliability and stability is essential for the continued evolution of lightbar technology in public safety and emergency response applications.

### SUMMARY

Applicant recognized the problems noted above and conceived and developed embodiments of snap-in lightheads for lightbars, according to the present disclosure, which integrate a snapping bracket to secure an optical sub-assembly to a lightbar extrusion while maintaining thermal and mechanical coupling and eliminating additional fasteners.

In an embodiment, a lightbar optical assembly includes an extrusion and optical sub-assembly. The extrusion includes a base, a mating undercut, and a protrusion. The optical sub-assembly includes a mounting bracket having a mounting bracket base and mounting bracket front edge of the mounting bracket base, optical engines attachable to the mounting bracket, a control printed circuit board assembly (PCBA), and a snapping bracket having snapping legs. The snapping bracket is secured to the mounting bracket and the control PCBA and is attachable to the extrusion. The mounting bracket front edge contacts the mating undercut and the snapping legs contact the protrusion thereby securing the optical sub-assembly to the extrusion.

In another embodiment, an optical assembly includes a mounting bracket having one or more face plates, one or more optical engines, a control printed circuit board assembly (PCBA), and a snapping bracket secured to the mounting bracket and the control PCBA. Each of the one or more optical engines is attachable to each of the one or more face plates.

### BRIEF DESCRIPTION OF DRAWINGS

The systems and methods described herein will be better understood on reading the following detailed description of non-limiting embodiments thereof, and on examining the accompanying drawings, in which:

FIG. 1 is an exploded isometric view of an optical assembly, in accordance with embodiments of the present disclosure;

FIG. 2 is an exploded side view of a lightbar optical assembly, in accordance with embodiments of the present disclosure;

FIG. 3 is a top view of a sub-assembly of mounting and snapping brackets with a control printed circuit board assembly (PCBA), in accordance with embodiments of the present disclosure;

FIG. 4 is a top view of a sub-assembly of mounting and snapping brackets, in accordance with embodiments of the present disclosure;

FIG. 5 is a zoomed-in top view of the sub-assembly of mounting and snapping brackets, in accordance with embodiments of the present disclosure;

FIG. 6 is a cross-sectional isometric view of a lightbar optical assembly in an engaged state, in accordance with embodiments of the present disclosure;

FIG. 7 is a top view of an optical arrangement of optical engines, in accordance with embodiments of the present disclosure;

FIG. 8 is a top view of an optical engine secured to a face plate of a mounting bracket, in accordance with embodiments of the present disclosure;

FIG. 9 is an isometric view of a lightbar optical assembly that is fully assembled, in accordance with embodiments of the present disclosure; and

FIG. 10 is a rear view of an optical assembly with ribbon harnesses, in accordance with embodiments of the present disclosure.

### DETAILED DESCRIPTION

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose. Additionally, like reference numerals may be used for like components, but such use should not be interpreted as limiting the disclosure.

When introducing elements of various embodiments of the present disclosure, the articles “a”, “an”, “the”, and “said” are intended to mean that there are one or more of the elements. The terms “comprising”, “including”, and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments”, or “other embodiments” of the present disclosure are not intended to be interpreted as excluding the existence of additional embodiments that also incorporate the recited features. Furthermore, reference to terms such as “above”, “below”, “upper”, “lower”, “side”, “front”, “back”, or other terms regarding orientation or direction are made with reference to the illustrated embodiments and are not intended to be limiting or exclude other orientations or directions. Moreover, references to “substantially” or “approximately” or “about” may refer to differences within ranges of +/- 10 percent. Furthermore, like numbers may be used to refer to like elements throughout, but it should be appreciated that using like numbers is for convenience and clarity and not intended to limit embodiments of the present disclosure. For example, one or more subsequent figures may share similar features with one or more prior figures and the similar features may be identified with like reference numerals for convenience purposes only and not to limit the scope of the present disclosure.

Embodiments of the present disclosure may be directed toward a snap-in lighthead for a lightbar, where light sources on a lighthead can be mounted onto a lightbar extrusion without the need for additional fasteners. Such embodiments of the present disclosure may integrate a snapping mechanism directly into a rigid optical sub-assembly, offering a streamlined and efficient solution for securing various lighting sources onto existing lightbar equipment. The embodiments described herein may be directed towards achieving a robust and reliable assembly that simplifies the installation process at an “upstream” level while maintaining efficient thermal and mechanical coupling between various components. Further, the embodiments described herein may be used with other extrusion-based mounting systems.

In various embodiments, the lightbar assembly comprises a lightbar extrusion, an optical engine, a mounting bracket, a snapping bracket, and a control printed circuit board assembly (PCBA). The optical engine may include silicone and polycarbonate optics working in conjunction with an illumination PCBA, providing precise and effective lighting. The mounting bracket, which may be made from aluminum sheet metal, may serve as the backbone of the assembly, ensuring thermal and mechanical coupling between the lightbar extrusion and the lighting sources. The snapping bracket may be designed to mount the control PCBA and secure the entire assembly to the lightbar extrusion through its integrated snapping mechanism.

Another embodiment of the present disclosure encompasses an assembly process, where the control PCBA is connected to the snapping bracket using fasteners, such as screws. The snapping bracket may then be located onto the mounting bracket using guide pins on the mounting bracket, ensuring accurate alignment and secure attachment. The control PCBA and snapping bracket may together slide towards the mounting bracket, until the guide pins are secured within the slots in the snapping bracket. The optical engines may be installed and secured one at a time, resulting in a sub-assembly that can be warehoused and later installed onto the lightbar extrusion in the final lightbar assembly. The processes described herein may eliminate the need for additional fasteners, which may streamline the assembly process and enhance the overall efficiency and reliability of the lightbar. However, it should be appreciated that in some embodiments, at least one fastener may be used to further secure of the components of the lightbar assembly and the optical sub-assembly.

Other embodiments of the present disclosure may involve design changes such as reducing the size of the control PCBA or changing the shape of the PCBA. Modifications may also be made to the snapping bracket that may comprise changing the size, shape, or snapping and tension mechanisms of the snapping bracket. In some embodiments, the snapping bracket may be removed altogether and instead utilize an existing snapping bracket. Such alternative embodiments may allow for modifications that can further optimize the assembly process and functionality of the lightbar.

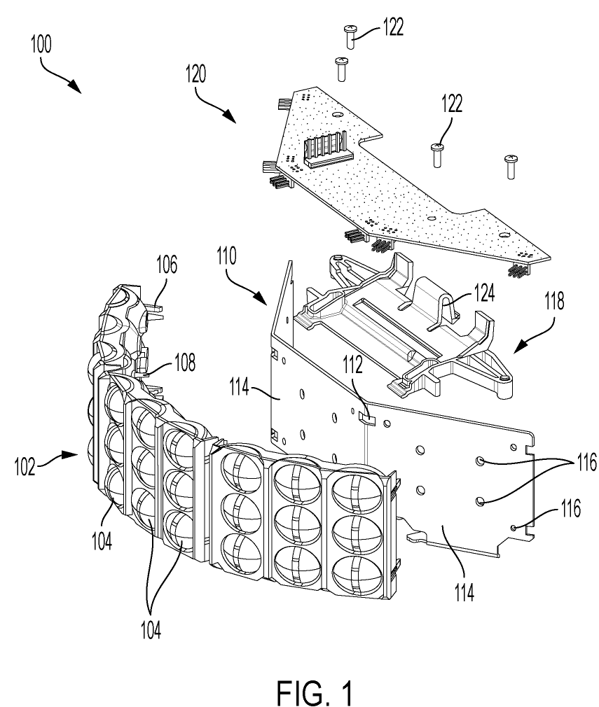

FIG. 1 is an exploded isometric view of an optical sub-assembly 100 which may include one or more optical engines 102. The one or more optical engines 102 may include one or more optics 104, which may be arranged in one or more columns and rows (as described later). The optical engines 102 may comprise LEDs as light sources, along with optical components such as lenses or reflectors. Further, the columns and rows of optics 104 in each optical engine 102 may have predetermined aiming angles for the optical engines 102, such that light from the LEDs is emitted in one or more predetermined directions. In some embodiments, each of the one or more optics 104 may include a collecting optic, which may be a reflector. The collecting optic may be integrated into a cradle that holds a concentrating lens, or may be a separate component connected to the cradle. As an example, the collecting optic may be a metallicized opening at the bottom of the cradle that reflects light from the LED out of the optical engine 102.

The one or more optical engines 102 may also include one or more snapping arms 106, which may be designed to secure the one or more optical engines 102 to a mounting bracket 110 of the optical sub-assembly 100. The mounting bracket 110 may be made of aluminum, such as 1/16” thick aluminum sheet metal, however, the mounting bracket 110 may be made of other metals or other materials.

The one or more optical engines 102 may also include one or more arms 108. The one or more arms 108 may be designed to be received by one or more openings 112 of the mounting bracket 110 and engage each optical engine 102 of the one or more optical engines 102 to each plate 114 of the mounting bracket 110. In an embodiment, two snapping arms 106 and one arm 108 from each of two optical engines 102, may be received in a single opening 112. Additionally, each of the one or more arms 108 may be received by one or more apertures 116 of the mounting bracket 110, which may function to ensure alignment of each of the one or more optical engines 102 with each of the one or more plates 114 of the mounting bracket 110. The one or more apertures 116 may also receive a fastener (e.g., a screw, bolt, etc.) to secure the one or more optical engines 102 to each of the one or more plates 114 of the mounting bracket 110.

Additionally, the optical sub-assembly 100 may include a snapping bracket 118. The snapping bracket 118 may first attach to a control PCBA 120, and then attach to the mounting bracket 110, which is described in more detail below. When the snapping bracket 118 is secured to the PCBA 120, and, in turn, secured to the mounting bracket 110 containing the one or more optical engines 102, such arrangement may be referred to as an “optical sub-assembly,” a “lighthead sub-assembly,” or simply a “lighthead.” When the optical sub-assembly is further secured to a lightbar extrusion (not depicted in FIG. 1), such arrangement may be referred to as a “lightbar optical assembly,” a “lightbar assembly,” or simply a “lightbar.” In securing one or more components of the optical sub-assembly to each other, one or more fasteners 122 may be utilized. The one or more fasteners 122 depicted in FIG. 1 are screws, however, the one or more fasteners 122 may be bolts, clamps, or any other suitable fastening means.

In various embodiments, the snapping bracket 118 serves as a carriage to mount the control PCBA 120 to the mounting bracket 110, setting the height for the board-to-board connection between the control PCBA 120 and the optical engines 102. The snapping bracket 118 may also have a snapping mechanism, such as one or more snapping legs 124 molded into the snapping bracket 118. The full sub-assembly 100, when fully assembled, may use the snapping legs 124 to secure itself to an extrusion (not depicted in FIG. 1). Furthermore, the snapping bracket 118 may provide the force to maintain thermal contact between the mounting bracket 110 and the extrusion. In some embodiments, the snapping bracket 118 is molded. In an embodiment, the snapping bracket 118 is molded in glass-filled nylon, however, it should be appreciated that the snapping bracket 118 may be molded in any other suitable polymer. In other embodiments, the snapping bracket 118 may also be any other suitable material other than polymer.

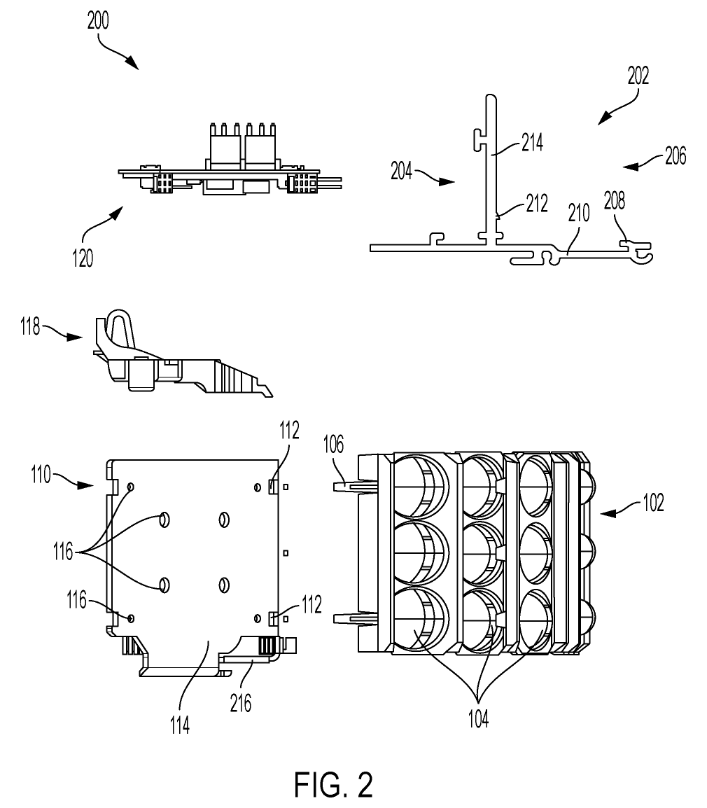

FIG. 2 is an exploded side view of a lightbar optical assembly 200, which contains many similar components as the optical sub-assembly 100 of FIG. 1, such as the optical engines 102, mounting bracket 110, snapping bracket 118, and control PCBA 120. The lightbar optical assembly 200 depicted in FIG. 2. further includes a lightbar extrusion 202. The extrusion 202 may be mounted on a vehicle, such as an emergency vehicle. The extrusion 202 may mount to the emergency vehicle on a vehicle mount side 204 of the extrusion 202. On the other side of the extrusion 202 may be a lighthead side 206 of the extrusion 202. On the lighthead side 206 of the extrusion 202, there may be a mating undercut 208 on a extrusion base 210. Also on the lighthead side 206 of the extrusion 202 may be a protrusion 212 on a back plate 214 of the extrusion 202.

Also illustrated in FIG. 2, the mounting bracket 110 may include a mounting bracket base 216. The mounting bracket base 216 may interface with the extrusion base 210 during the assembly of the lighthead optical sub-assembly 100 onto the lightbar extrusion 202 to form the lightbar optical assembly 200. The interfacing may include thermal contact that allows heat generated from the optical engines 102 that is transferred to the mounting bracket 110, to be transferred to the extrusion 202 through the interface, and into the larger extrusion 202. In other words, the interfacing of the components acts as a heat sink for the one or more optical engines 102.

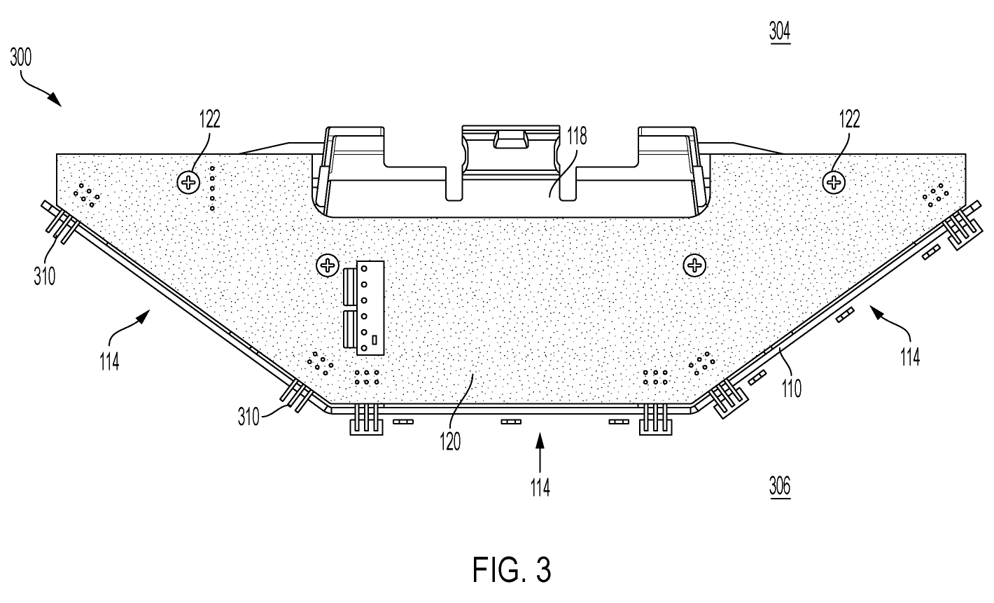

FIG. 3 is a top view of a sub-assembly 300 of the mounting bracket 110 and the snapping bracket 118 with a control PCBA 120. The snapping bracket 118 may be secured to the control PCBA 120 with one or more fasteners 122, and the snapping bracket 118 may be located substantially underneath the control PCBA 120. The snapping bracket 118 may protrude past the control PCBA 120 on a rear 304 of the sub-assembly 300. The rear of the sub-assembly 300 may also be referred to as the “extrusion side” or the “mounting side” of the sub-assembly 300. On the opposite side as the rear side 304, there may be a front side 306 of the sub-assembly 300. The front side 306 of the control PCBA 120 may have three equal-length sides that may generally correspond to and may generally be located adjacent to the three plates 114 of the mounting bracket 110.

Furthermore, the control PCBA 120 may have one or more electrical connections 310 around the perimeter of the control PCBA 120 on the front side 306 of the control PCBA 120. The one or more electrical connections 310 may extend through or otherwise protrude through one or more openings 112 (discussed above; not depicted in FIG. 3) of the mounting bracket 110. In fact, the location of the one or more openings 112 may be designed so that the one or more electrical connections 310 are not damaged during assembly/fabrication of the sub-assembly 300. In the embodiment depicted in FIG. 3, there are six electrical connections 310 on the control PCBA 120, and there are two electrical connections 310 protruding through each plate 114 of the mounting bracket 110.

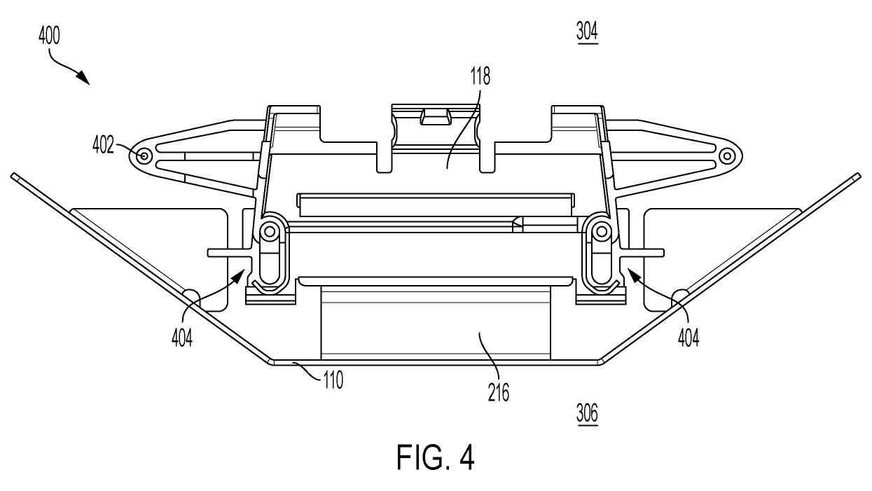

FIG. 4 is a top view of a sub-assembly 400 of the mounting bracket 110 and the snapping bracket 118. Notably, the sub-assembly 400 of FIG. 4 does not include the control PCBA 120, unlike FIG. 3, and FIG. 4 is the view of the sub-assembly 300 of FIG. 3, but with the control PCBA 120 removed from the top of the sub-assembly 300. With the control PCBA 120 removed from the sub-assembly 400, one or more holes 402 of the snapping bracket 118 can be seen. The one or more holes 402 may be configured to receive the one or more fasteners 122 in assemblies in which the control PCBA 120 is attached to the snapping bracket 118. The one or more holes 402 may be threaded holes, when, for example, the one or more holes 402 are designed to receive one or more fasteners 122 that are screws. However, it should be appreciated that the one or more holes 402 may be smooth holes for receiving other types of fasteners 122. Additionally, it should be appreciated that the one or more holes 402 may be eliminated from the snapping bracket 118 in embodiments in which the fasteners 122 are not required for fastening or attaching the snapping bracket 118 to the control PCBA 120. As can be further seen in FIG. 4, the bracket base 216 of the mounting bracket 110 is located substantially toward the front side 306 of the sub-assembly 400, and the one or more holes 402 are located substantially toward the rear side 304 of the sub-assembly 400.

Further, in some embodiments, the snapping bracket 118 of the sub-assembly 400 may include one or more detents 404. In the embodiment depicted in FIG. 4, there are two detents 404, however, there may be any reasonable amount of detents 404 in the snapping bracket 118. As described above, when the snapping bracket 118 is located onto the mounting bracket 110 for assembly of the optical sub-assembly, the mounting bracket may have guide pins, which may ensure accurate alignment and secure attachment of the snapping bracket 118 to the mounting bracket 110. The snapping bracket 118 may slide towards the mounting bracket 110, until the guide pins push past the detents 404 that may be molded into slots of the snapping bracket 118. It should be appreciated, however, that there are various embodiments of the sub-assembly 400 that do not include the one or more detents 404.

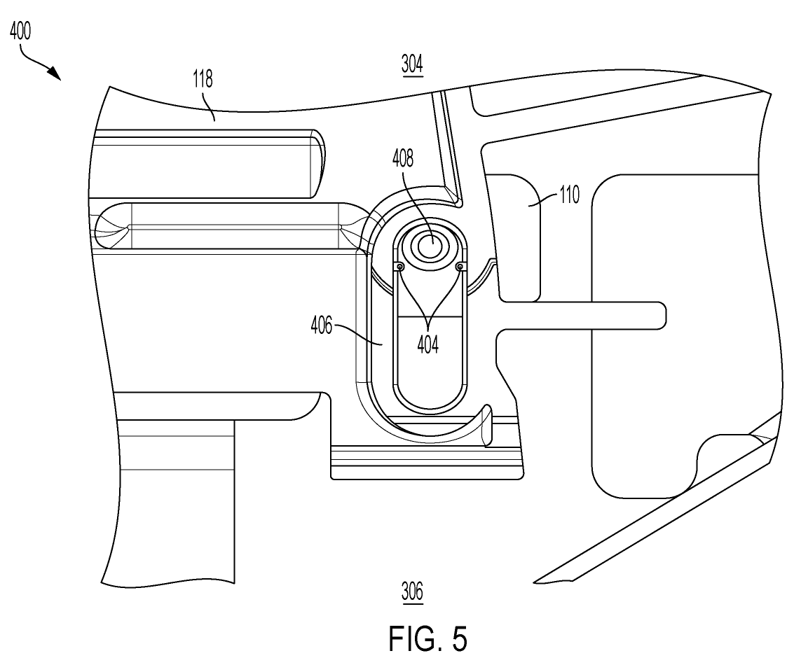

FIG. 5 is a zoomed-in top view of the sub-assembly 400 of FIG. 4, showing an embodiment with the one or more detents 404, in detail. As can be seen, the detents 404 are molded into one or more slots 406 in the snapping bracket 118. The detents 404 may have a rounded shape, a hooked shape, or a knob shape, depending on the embodiment. It should be appreciated that although there are two detents 404 shown and one slot 406 shown in FIG. 5, there may be any reasonable number of detents 404 per slot 406, including zero detents 404, and also there may be any reasonable number of slots 406 molded in the snapping bracket 118.

As is further illustrated in FIG. 5, the mounting bracket 110 may have one or more guide pins 408. The one or more guide pins 408 may be PEM inserts, which may be 4-40 standoffs, or any other type of standoff. The one or more guide pins 408 may also be nails, fasteners, or any other reasonable piece of hardware to act as a guiding pin. Additionally, the one or more guide pins 408 may be metal, such as aluminum, steel, stainless, steel, or brass, as well as any other type of material. The slots 406 may act as locating holes for the guide pins 408, which may act to ensure proper alignment of the snapping bracket 118 and the mounting bracket 110 when the optical sub-assembly is being constructed. The guide pins 408 may be inserted into the slots 406 towards the front side 306 of the slots 406 and then the guide pins 408 may move, within the slots 406, towards the rear side 304 of the slots 406 during the assembly of the sub-assembly 400. In embodiments that include detents 404, during the motion of the guide pins 408 within the slots 406, the guide pins 408 may push past the detents 404 until the guide pins 408 snap in place on the rear side 304 of the detents 404, thereby securing the guide pins 408 in the slots 406 and thereby locking the mounting bracket 110 to the snapping bracket 118. Such a position may be referred to as “a locking position” or “an engaged position.”

Again, it should be appreciated that there are embodiments of the sub-assembly 400 where the mounting bracket 110 does not include the one or more guide pins 408 and/or the snapping bracket 118 does not include the one or more slots 406 and one or more detents 404. In such embodiments that do not include pins and detents, the primary engagement of the sub-assembly 400 to the extrusion 202 is via: (i) the snapping legs 124 of the snapping bracket 118 engaging with and snapping underneath the protrusion 212 of the back plate 214 of the extrusion 202; and (ii) a clamping force between the snapping bracket 118 and the mating undercut 208 on the extrusion base 210.

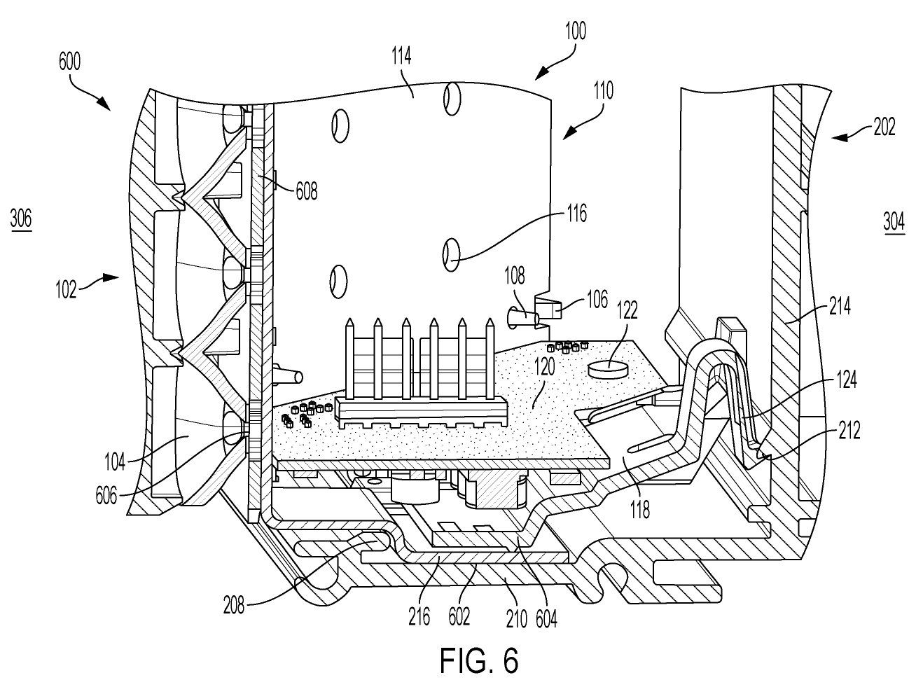

FIG. 6 is a cross-sectional isometric view of a lightbar optical assembly 600 in a fully-assembled state (e.g., “an engaged state”). Similar to various embodiments discussed herein, the lightbar optical assembly 600 may include the one or more optical engines 102 that each may contain the one or more optics 104. The lightbar optical assembly 600 may also include the lightbar extrusion 202, the mounting bracket 110 having a mounting bracket base 216 and one or more plates 114, the snapping bracket 118, the control PCBA 120 secured to the snapping bracket 118 with one or more fasteners 122. Additionally, the arms 108 of the optical engines 104 may extend through one or more apertures 116 of the plate 114 of the mounting bracket 110, and the snapping arms 106 may secure the optical engines 104 to each plate 114 of the mounting bracket 110. Further, the lightbar extrusion 202 may have an extrusion base 210 and an extrusion back plate 214.

The cross-sectional view of the lightbar optical assembly 600 shows the engaged state of the lightbar optical assembly 600. Notably, FIG. 6 depicts how the optical sub-assembly 100 is attached to and retained in the lightbar extrusion 202 to create the lightbar optical assembly 600. During assembly, the mounting bracket base 216 may catch or otherwise make contact with the mating undercut 208 on the extrusion 202 and the mounting bracket 110 may rotate inward and toward the rear side 304 of the lightbar optical assembly 600, toward the extrusion 202. As the optical sub-assembly 100 rotates toward and makes contact with the extrusion 202, the mounting bracket base 216 may make thermal contact with the extrusion base 210 when in the optical sub-assembly 100 is in its final resting position on the lightbar extrusion 202. The location of the thermal contact between the extrusion base 210 and the mounting bracket base 216 may occur at a thermal interface 602. The thermal interface 602 may allow for heat generated from the optics 104 of the optical engines 102 to be transferred to the mounting bracket 110, then transferred through the mounting bracket base 216 to the extrusion base 210, and then to the extrusion 202.

Furthermore, also as the optical sub-assembly 100 rotates toward and makes contact with the extrusion 202, the snapping legs 124 of the snapping bracket 118 engage with and snap underneath the protrusion 212 of the back plate 214 of the extrusion 202. The snapping legs 124, by bending and having spring force upon the engagement of the snapping legs 124 with the protrusion 212 on the extrusion, retains tension on the mounting bracket base 216 through a snapping bracket base 604 of the snapping bracket 118. The snapping bracket base 604 may press or otherwise apply force on the top of the mounting bracket base 216, which thereby may maintain the thermal interface 602 between the mounting bracket base 216 and the extrusion base 210. Such engagement of the snapping bracket 118 with the extrusion 202 may ensure the mechanical stability of the lightbar optical assembly 600 and may ensure proper thermal contact between various components in the lightbar optical assembly 600. Such engagement may also allow for the lightbar optical assembly 600 to be fully assembled and remain intact without the need for additional fasteners or hardware to maintain thermal and mechanical coupling of the various components within the lightbar optical assembly 600.

Also as illustrated in FIG. 6, the one or more optics 104 may include one or more LEDs 606. The one or more LEDs 606 may be of different colors or may be of the same color. Additionally, the one or more LEDs 606 may be mounted on an illumination printed circuit board (PCB) 608 that may be positioned substantially behind the optics 104 and adjacent to the mounting bracket 110. The illumination PCB 608 may control the lighting of the one or more LEDs 606 in the one or more optics 104. Furthermore, the illumination PCB 608 may be electrically connected to the control PCBA 120 and be configured to receive control signals from the control PCBA 120. Such control signals may include which optical engine 102 to illuminate, which optics 104 within an optical engine 102 or across optical engines 102 to illuminate, which rows or columns of optics 104 to illuminate, and which direction the optics 104 should be oriented. In an embodiment, the control PCBA 120 may be electrically connected to the illumination PCB 608 through wiring or other connectors that pass through the one or more apertures 116 of the mounting bracket 110.

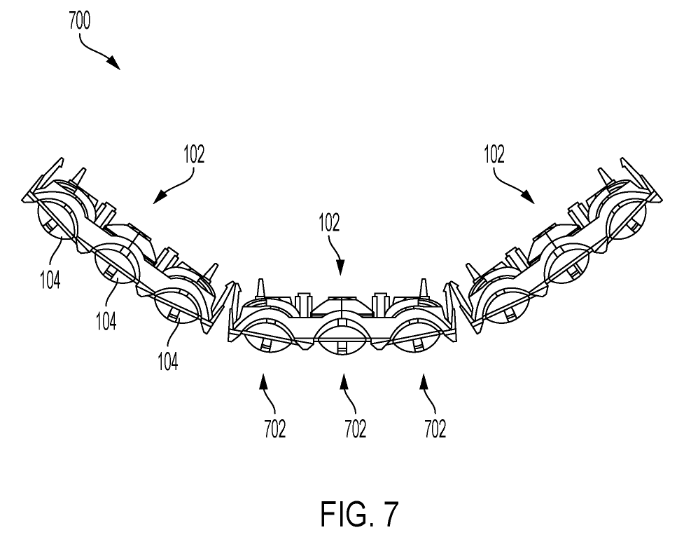

FIG. 7 is a top view of an optical arrangement 700 of multiple optical engines 102. Each of the optical engines 102 has one or more optics 104. It should be appreciated that although there are three optical engines 102 shown in FIG. 7, there may be any reasonable number of optical engines 102 included in the optical arrangement 700. The optics 104 of each of the optical engines 102 are arranged in columns 702. It should be appreciated that although there are three columns 702 of optics 104 in each of the optical engines 102, there may be any reasonable number of columns 702 of optics 104 in each of the optical engines 102.

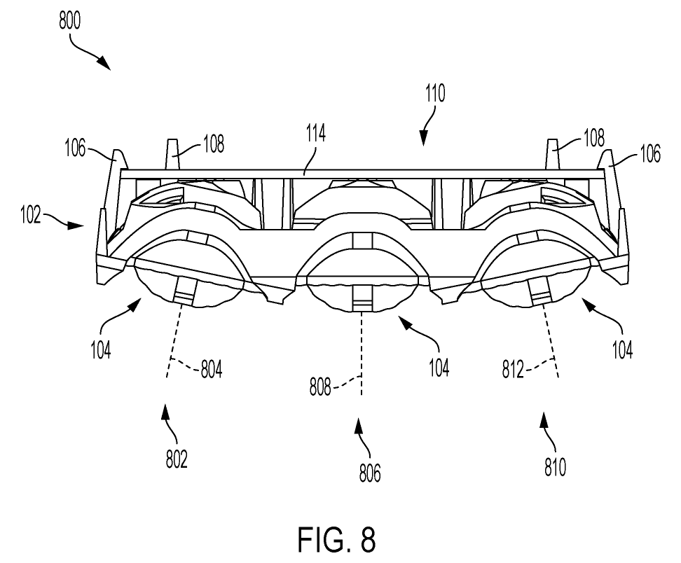

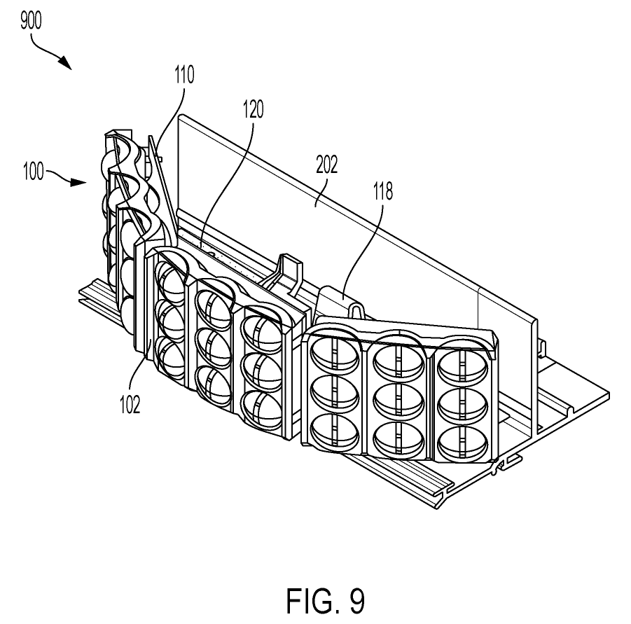

The optics 104 are positioned in each of the optical engines 102 in the arrangement 700 in three columns and three rows, however, there may be any reasonable amount of columns and rows of optics 104. Moreover, in the embodiment illustrated in FIG. 7, each optic 104 of each optical engine 102 in the arrangement 700 is oriented to emit light in a different direction. However, it should be appreciated that each optic 104 may be oriented to point in the substantially same direction. Additionally, it should be appreciated that each optic 104 of a given optical engine 102 may be oriented to point in the same direction, however, this direction may be different between each optical engine 102 as a whole. Furthermore, optics 104 of a given column may be oriented in different directions relative to each other to emit light in different directions (e.g., some optics 104 may be pointing more downwards and some optics 104 may be pointing more upwards). For example, optics 104 in the top row may be pointing substantially upwards, optics 104 in a middle row may be pointing substantially straight ahead, and optics 104 in the bottom row may be pointing substantially downwards, or any other reasonable combination or arrangement of the foregoing. Additionally, the control PCBA 120 may control the direction of light emitted from each individual optic 104 within each optical engine 102, and the control PCBA may control the direction that optics 104 of a certain row or column emit light in. The arrangements of columns and rows is explained in more detail below, with reference to FIGS. 8 and 9.

FIG. 8 is a top view of a system 800 of an optical engine 102 secured to a face plate 114 of a mounting bracket 110. As can be seen, two snapping arms 106 can be seen on both sides of the plate 114 that function to secure the optical engine 102 to the plate 114 of the mounting bracket 110. Additionally, the system 800 illustrated has two arms 108 that protrude or otherwise extend through the plate 114 of the mounting bracket 110.

Furthermore, in the embodiment illustrated in FIG. 8, a first column 802 of one or more optics 104 is oriented at a first direction 804, a second column 806 of one or more optics 104 is oriented at a second direction 808, and a third column 810 of one or more optics 104 is oriented at a third direction 812. The first direction 804 may be at any reasonable angle relative to the second direction 808 and the second direction 808 may be at any reasonable angle relative to the third direction 812. Also, the angle between the first direction 804 and the second direction 808 may be substantially the same angle as the angle between the second direction 808 and the third direction 812. Furthermore, depending on the particular embodiment, the second direction 808 may be perpendicular to the plate 114 of the mounting bracket 110, whereas the first direction 804 and third direction 812 may be at an angle oblique to the plate 114. However, the first, second, and third directions 804, 808, and 812 may be at any reasonable angle relative to the plate 114.

In an embodiment, each column 802, 806, 810 of optics 104 may be oriented at an angle that is, for example, 60 degrees offset from the angle of the column 802, 806, 810 on either side of it. For instance, in such embodiment, there may be a first column oriented at 0 degrees, a second column oriented at 60 degrees, a third column oriented at 120 degrees, a fourth column oriented at 180 degrees, a fifth column oriented at 240 degrees, and a sixth column oriented at 300 degrees. In such an arrangement, for example, the fourth column is at an angle of 60 degrees from the third column and at an angle of 60 degrees from the fifth column. Also in such arrangement, there are six total columns of optics 104 that extend substantially in a full circle, for a 360 degree arrangement. However, it should be appreciated that the columns of optics 104 could be at progressive angles of 1, 2, 3, 5, 10, 15, 20, 30, 45, 60, 90, 120, 180, or any reasonable angle. In other embodiments, the columns 802, 806, 810 may extend in a half-circle, for a 180 degree arrangement, or the columns 802, 806, 810 may extend in any other reasonable arrangement.

In various embodiments, within a single optical engine 102, the optics 104 may be diversified to produce complementary beam coverage. Within a single 3×3 optical engine 102, the nine optics 104 may be homogeneous or heterogeneous, including different beam profiles such as spot, flood, elliptical, asymmetric, total internal reflection (TIR), or compound reflector geometries. Individual optics may be configured for distinct wavelengths or colors (e.g., red, blue, amber, white, ultraviolet, etc.), and may include polarization or diffuser structures to tailor output. In an example, individual rows or columns within a single optical engine 102 are pre-assigned to specific colors—such as a top row of red, a middle row of white, and a bottom row of blue—to achieve vertical stratification of color effects. The control PCBA 120 may incorporate independent current-control channels per light source and calibration for color and intensity, enabling precise per-optic control and color blending within a single optical engine 102.

In some embodiments, the optical engine 102 may have a layout of optics 104 in arrangements other than a 3×3 arrangement. For example, the optics 104 may be provided in arrangements such as 2×2 or 1×3. Such arrangements may be implemented, for example, where needed to fill geometric gaps in an oval, hexagon, or octagon fixture, or to accommodate constrained mounting spaces.

In various embodiments, the optical engine 102 (such as the optical engine 102 depicted in FIG. 8) may function as a modular building block that can be replicated, tiled, combined, or otherwise arranged and provided on larger structures, including but not limited to lightbars and multi-faceted fixtures. An example of a multi-faceted fixture that the optical engines 102 could be provided on is a hexagonal fixture with one or more optical engines 102 (or, e.g., “optical modules 102”) disposed around a perimeter of the hexagonal fixture. In another embodiment, multiple optical modules 102 are integrated into a circular or oval-shaped fixture, or another shape of fixture with curved sides. Optical modules 102 on the edges may be angled to provide wraparound visibility, while optic orientations within each module 102 may be rotated or indexed to harmonize beam overlap and uniformity around the curved shape of the fixture.

Furthermore, the fixture that the optical modules 102 are mounted on may be functionally zoned by direction. For example, forward-facing optical modules may provide bright forward illumination to shine direct light on the scene of a situation, such as a crash, an accident, a traffic stop, etc. Lateral-facing or rear-facing optical modules may provide emergency lighting, such as red and blue flashing or alternating emergency lights. Rear-facing modules may further implement hazard signaling or scene backlighting. Modules may further be synchronized together to generate coherent rotating, sweeping, waving, or alternating patterns that traverse the perimeter of the fixture, such as in a clockwise or counterclockwise fashion without mechanical motion. The system may support synchronization signals (e.g., wired or wireless) to coordinate patterns across the various optical modules in the fixture.

The optical modules 102 within a fixture may provide directional functional zoning based on module orientation and optical selection. In some embodiments, modules oriented forward, downward, or outward may be assigned to scene illumination, employing bright white light, that is broad and uniform. Modules oriented laterally or rearward may be assigned to emergency warning functions using red, blue, or other colors with high-intensity pulse profiles or synchronized flash sequences. Additionally, optical modules 102 may have one or more color-specific optics to support multi-color warning and scene lighting within a single module. Moreover, some modules of a fixture may be dedicated to utility or task functions, such as search beams, with narrow optics and adjustable tilt for targeted illumination.

In embodiments, the optics modules 102 are arranged in other polygonal shapes besides the hexagonal fixture. For example, the fixture may be a triangular fixture, rectangular fixture, octagonal fixture, or other multi-faceted polygonal fixtures. Each face of the polygonal fixture may host one or more optical modules 102, and each face may be oriented at a predetermined azimuth to collectively provide 360-degree coverage. Corner or transition faces may employ optics with wider beam divergence to fill inter-facet gaps, while adjacent faces may be overlapped to provide uniform circumferential coverage.

The polygonal fixture may further be implemented as a single tier or as multiple stacked tiers to produce an expanded vertical lighting fixture, where lower tiers provide ground-directed scene lighting and upper tiers provide elevated warning visibility. Upper or lower optics within the modules may also implement vertical stratification where an upper tier or row prioritizes warning lights and a lower tier or row prioritizes scene illumination.

Furthermore, optical modules 102 can be packaged in low-profile housings suitable for roof mounting, grille integration, or peripheral vehicle placement, and may include quick-release mounts (e.g., with snapping legs) to allow rapid replacement or reconfiguration, and to allow for maintenance and replacement of one or more modules 102.

FIG. 9B is a top view of a lightbar 950 with one or more optical assemblies 102 (e.g., “optical modules 102”) disposed at each end of the lightbar 950. In the example embodiment depicted in FIG. 9B, there are three optical modules 102 disposed at each of two ends of the lightbar 950. As with the fixture 900 of FIG. 9A, the lightbar 950 has a support structure 954 that provides the general structure of the lightbar 950. Further shown in FIG. 9B are other light elements 952. The other light elements 952 may be positioned on certain sides of the lightbar 950, such as in FIG. 9A, where the other light elements 952 are positioned on the long sides of the lightbar 950, while the optical modules 102 are disposed the ends of the lightbar 950. In another embodiment, the other light elements 952 may be interspersed with the optical modules 102 around the perimeter of the lightbar 950.

As with embodiments of the fixtures 900 described herein, the optical modules 102 may have different colors, patterns, functions, orientations, etc. within the lightbar 950. For example, in an embodiment, the other light elements 954 provide forward, bright scene lighting for an emergency situation or traffic stop, while the optical modules 102 on the ends of the lightbar 950 provide red and blue flashing, alternating, or pulsing emergency warning lights

FIG. 9 is an isometric view of a lightbar optical assembly 900 that is in a fully assembled state. As is illustrated, there may be three optical engines 102 secured to the mounting bracket 110, which, in turn, is secured to the snapping bracket 118 that is attached to the control PCBA 120. The optical engines 102, the mounting bracket 110, the snapping bracket 118, and the control PCBA 120 may comprise the optical sub-assembly 100. The optical sub-assembly 100 is shown in FIG. 9 as attached to the lightbar extrusion 202, which, together, comprises the lightbar optical assembly 900.

Moreover, multiple optical sub-assemblies 100 may be connected together, including at different angles with respect to each other. For example, multiple optical sub-assemblies 100 may be connected linearly or at angles such that the optical sub-assemblies 100 form a curve. In this manner, multiple optical sub-assemblies 100 could be connected together to form a lightbar with two ends formed by optical sub-assemblies 100 connected at angles to one another forming curved ends, and multiple optical sub-assemblies 100 connected together linearly along the sides of the lightbar. Two or more optical sub-assemblies 100 may be connected to a single mounting bracket 110, or each optical sub-assembly 100 may be connected to its own mounting bracket 110. Mounting brackets 110 to which one or more optical sub-assemblies 100 are attached may be connected together, or may be connected to a common mounting structure, for example, for mounting on the extrusion 202.

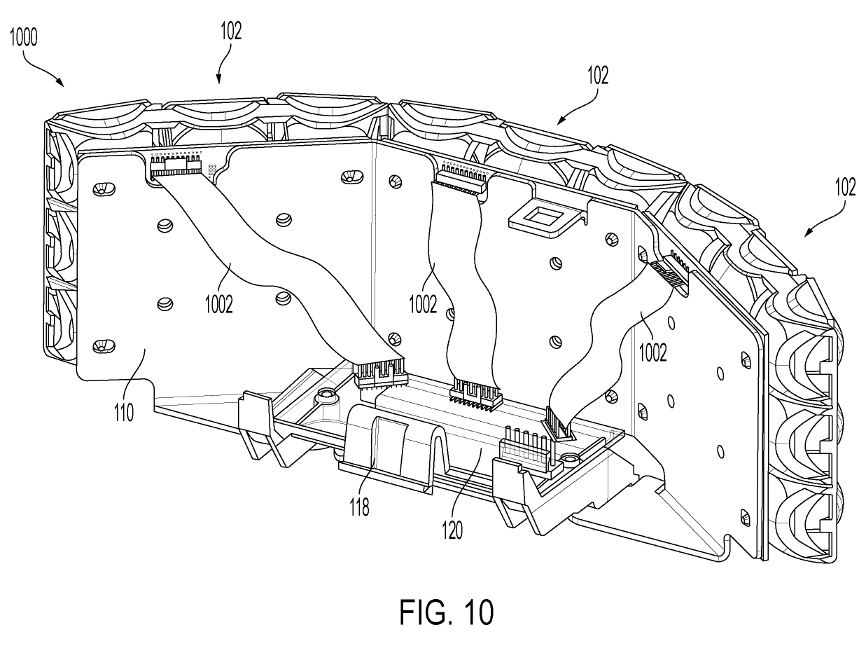

FIG. 10 is a rear view of an embodiment of an optical assembly 1000 that may include one or more ribbon harnesses 1002. Also depicted in FIG. 10 is the snapping bracket 118, mounting bracket 110, and other features discussed with respect to other embodiments herein. The one or more ribbon harnesses 1002 may electrically couple the control PCBA 120 to the illumination PCBs 608 of the optical engines 102, which may distribute power, ground, and control signals (e.g., on/off, dimming, and sequencing signals) from the control electronics to selected optics 104 of a plurality of optics 104. In the embodiment illustrated in FIG. 10, there are three ribbon harnesses 1002 connecting the control PCBA 120 to each of three optical engines 102. However, it should be appreciated that there may be any reasonable number of ribbon harnesses 1002 in the optical assembly 1000 and any reasonable number of optical engines 102. The number of ribbon harnesses 1002 may be influenced by the number of optical engines 102 implemented in the optical assembly 1000.

In the embodiment illustrated in FIG. 10, the ribbon harnesses 1002 may be hanging loosely on the rear side of the optical assembly 1000. In at least one embodiment, the one or more ribbon harnesses 1002 may be routed along the rear of the optical assembly 1000 and through apertures 116 in the mounting bracket 110.

The one or more ribbon harnesses 1002 may be implemented as flexible flat cables (FFC), flexible printed circuits (FPC), or multi-conductor ribbonized wire assemblies, and may include any suitable number of conductors, gauges, and pitches to accommodate the required current and signal integrity. The one or more ribbon harnesses 1002 may be solid or stranded and may be insulated with polyimide, polyethylene terephthalate (PET), polyvinyl chloride (PVC), silicone, or other suitable materials. Termination to the PCBA 120 and/or illumination PCBs 608 can be achieved via insulation-displacement connectors, crimp-and-housing connectors, board-to-board or mezzanine connectors, zero insertion force (ZIF) or FPC connectors, or soldered terminations, and may include latching, locking, keying, or strain-relief features. The one or more ribbon harnesses 1002 may be keyed and color-coded or labeled to prevent misconnection. Multiple ribbon harnesses 1002 may be managed with clips, guides, channels in the lightbar extrusion 202, tapes, or adhesives to control bend radius and mitigate vibration-induced fatigue. In other embodiments, the one or more ribbon harnesses 1002 may be partially or fully integrated into the snapping bracket 118 or mounting bracket 110, or replaced by direct board-to-board interconnects, while still providing the foregoing electrical coupling functions.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

What is claimed is:

1. A lightbar optical assembly, comprising:
an extrusion comprising:
an extrusion base;
a mating undercut; and
a protrusion; and
an optical sub-assembly, comprising:
a mounting bracket, comprising:
a mounting bracket base; and
a mounting bracket front edge of the mounting bracket base;
one or more optical engines attachable to the mounting bracket;
a control printed circuit board assembly (PCBA); and
a snapping bracket comprising one or more snapping legs, wherein the snapping bracket is secured to the mounting bracket and the control PCBA, and wherein the snapping bracket is attachable to the extrusion;
wherein the mounting bracket front edge contacts the mating undercut and wherein the one or more snapping legs contacts the protrusion thereby securing the optical sub-assembly to the extrusion.

2. The lightbar optical assembly of claim 1, wherein the mounting bracket base and the extrusion base are in thermal contact via an interface.

3. The lightbar optical assembly of claim 1, wherein the snapping bracket comprises one or more apertures configured to receive fasteners that secure the control PCBA assembly to the snapping bracket.

4. The lightbar optical assembly of claim 1, wherein each of the one or more optical engines comprises a plurality of optics.

5. The lightbar optical assembly of claim 4, wherein each optic of the plurality of optics comprises at least one LED.

6. The lightbar optical assembly of claim 1, wherein the one or more optical engines are secured to the mounting bracket by one or more snapping arms, the one or more snapping arms received in openings of the mounting bracket.

7. The lightbar optical assembly of claim 1, further comprising:
an illumination printed circuit board associated with each optical engine of the one or more optical engines.

8. The optical assembly of claim 7, wherein the illumination printed circuit board is electrically connected to the control PCBA.

9. The lightbar optical assembly of claim 8, further comprising:
one or more ribbon harnesses, the one or more ribbon harnesses electrically connecting the illumination printed circuit board and the control PCBA.

10. The lightbar optical assembly of claim 1, wherein the one or more optical engines comprise at least:
a first optical engine positioned at a first angle; and
a second optical engine positioned at a second angle, wherein the first angle is oblique to the second angle.

11. An optical assembly, comprising:
a mounting bracket comprising one or more face plates;
one or more optical engines, wherein each of the one or more optical engines is attachable to each of the one or more face plates;
a control printed circuit board assembly (PCBA); and
a snapping bracket secured to the mounting bracket and the control PCBA.

12. The optical assembly of claim 11, wherein the snapping bracket comprises one or more apertures configured to receive fasteners that secure the control PCBA to the snapping bracket.

13. The optical assembly of claim 11, wherein each of the one or more optical engines comprises a plurality of optics.

14. The optical assembly of claim 13, wherein each optic of the plurality of optics comprises at least one LED.

15. The optical assembly of claim 11, wherein the one or more optical engines are secured to the mounting bracket by one or more snapping arms, the one or more snapping arms received in openings of the mounting bracket.

16. The optical assembly of claim 11, further comprising:
an illumination printed circuit board associated with each optical engine of the one or more optical engines.

17. The optical assembly of claim 16, wherein the illumination printed circuit board is electrically connected to the control PCBA.

18. The optical assembly of claim 17, wherein the illumination printed circuit board is electrically connected to the control PCBA via one or more ribbon harnesses.

19. The optical assembly of claim 11, wherein the one or more optical engines comprise at least:
a first optical engine positioned at a first angle; and
a second optical engine positioned at a second angle, wherein the first angle is oblique to the second angle.

20. The optical assembly of claim 11, wherein the snapping bracket comprises one or more snapping legs configured to secure the optical assembly to a lightbar.
